(19) United States
(12) Patent Application Publication
(10) Pub. No.: US 2026/0061700 A1
(43) Pub. Date: Mar. 5, 2026

(54) ROTATABLE MULTI-NOZZLE EXTRUSION SYSTEM FOR 3D PRINTING

(71) Applicant: Wayne State University, Detroit, MI (US)

(72) Inventors: Yara Almubarak, Detroit, MI (US); Mohammed Al-Ali, Dearborn, MI (US)

(21) Appl. No.: 19/311,085

(22) Filed: Aug. 27, 2025

Related U.S. Application Data
(60) Provisional application No. 63/688,498, filed on Aug. 29, 2024.

(51) Int. Cl. B29C 64/209; B29C 48/00; B29C 48/02; B29C 48/25; B29C 48/30; B29C 48/345; B29C 48/92; B29C 64/241; B29C 64/336; B29C 64/393; B33Y 30/00; B33Y 40/00; B33Y 50/02

(52) U.S. Cl. CPC B29C 64/209; B29C 48/02; B29C 48/022; B29C 48/2528; B29C 48/301; B29C 48/345; B29C 48/92; B29C 64/241; B29C 64/336; B29C 64/393; B33Y 30/00; B33Y 40/00; B33Y 50/02; B29C 2948/92828

(57) ABSTRACT

A rotatable extrusion system is disclosed. The system includes a syringe pump base including a multi-nozzle attachment disposed at a bottom of the base. A plurality of syringe pumps are mounted to the syringe pump base, the plurality of syringe pumps respectively including a pump motor and a material reservoir. A rotational motor is operatively coupled to the syringe pump base for rotating the plurality of syringe pumps about a rotation axis.

### CROSS REFERENCE TO RELATED APPLICATIONS

This U.S. patent application claims priority under 35 U.S.C. § 119(e) to U.S. Provisional Application 63/688,498, filed on Aug. 29, 2024. The disclosure of this prior application is considered part of the disclosure of this application and is hereby incorporated by reference in its entirety.

### TECHNICAL FIELD

The present disclosure relates to extrusion systems, and more particularly to a rotatable multi-nozzle extrusion system for three-dimensional (3D) printing applications that enables seamless material switching, improved flow control, and high throughput multi-material printing.

### BACKGROUND

Advancements in extrusion-based 3D printing technology have led to the development of multi-nozzle, multi-material systems. These offer benefits such as reduced printing time and the capability to print with various materials.

However, these systems face several challenges in achieving high-throughput printing, efficient material switching, and effective parallel operation. One primary issue is tube twisting: the entanglement of material supply lines during printing, which leads to flow restrictions, material inconsistencies, and potential failures.

Traditional nozzle switching relies on linear movement, requiring nozzles to be moved aside to prevent collisions. This approach limits the number of nozzles manageable, necessitates additional space and control systems, and increases complexity. It also reduces speed due to lengthy tool changes and restricts the printable geometries.

Furthermore, excessive distance between material reservoirs and nozzles can waste material, cause inconsistent flow, and complicate precise material switching. Longer material paths increase the risk of mixing and dirty transitions.

None of the existing systems provide a comprehensive solution that both reduces tube twisting and enables efficient material switching and parallel printing for 3D applications. Thus, there is a clear need for an improved extrusion system to address these shortcomings.

To overcome the limitations of existing multi-nozzle 3D printing systems, this disclosure presents a rotatable mechanism that prevents tube twisting, enables efficient material switching via rotational (rather than linear) motion, and facilitates scalable multi-material printing free from the constraints of traditional nozzle management methods.

### SUMMARY

The present disclosure provides a rotatable extrusion system specifically designed to enhance the performance and flexibility of multi-nozzle, multi-material 3D printing. The disclosure addresses the critical limitations of existing systems by providing a novel rotatable design that eliminates or reduces tube twisting, enables seamless material switching, improves flow control, and supports high throughput printing operations.

In various implementations, a rotatable extrusion system comprises a syringe pump base including a multi-nozzle attachment disposed at a bottom of the base, a plurality of syringe pumps mounted to the syringe pump base, the plurality of syringe pumps respectively including a motor and a material reservoir, and a rotational motor operatively coupled to the syringe pump base for rotating the plurality of syringe pumps about a rotation axis.

The rotatable extrusion system fundamentally differs from prior art systems by mounting the material reservoirs and pumps directly on the rotating assembly, thereby eliminating or reducing the tube twisting problem that plagues conventional multi-nozzle systems. By rotating the entire extrusion assembly as a unit, the relative positions of all material supply lines remain constant, preventing entanglement and maintaining consistent flow characteristics.

The system enables seamless material switching through simple rotation rather than complex linear movements. This rotational approach allows for printing parts with multiple materials in both sequential and parallel modes. In sequential mode, only one nozzle is activated at a time, and material changes are accomplished by rotating the appropriate syringe pump into the active position. In parallel mode, multiple syringe pumps can operate simultaneously to print identical geometries with different materials, significantly accelerating prototyping and production processes.

The disclosure provides significant advantages over linear switching systems by eliminating constraints on the number of nozzles, as system capacity is determined by the physical size of the rotating assembly rather than motion management requirements for individual nozzles. The rotational mechanism also provides faster switching compared to linear systems, as the switching motion is simplified to a single rotational degree of freedom.

Examples of the disclosure include systems with gear-driven rotation mechanisms and direct-drive transmission systems, each optimized for different applications and performance requirements. The system incorporates electrical slip rings to maintain power and control connections to the rotating components, enabling continuous rotation while preserving independent control of each syringe pump. The electrical slip rings prevent the control signal and power wires between the pump motors and the control board from twisting or becoming entangled.

The rotatable extrusion system is compatible with various nozzle configurations, including straight nozzles, bent nozzles, and advanced multi-nozzle attachments, providing flexibility for different printing applications and material requirements.

One aspect of the disclosure provides a rotatable extrusion system. The system includes a syringe pump base. A multi-nozzle attachment is disposed at a bottom of the syringe pump base. The system comprises a plurality of syringe pumps mounted to the syringe pump base, each syringe pump including a pump motor and a material reservoir. A rotational motor is operatively coupled to the syringe pump base. The rotational motor is configured to rotate the syringe pump base and the mounted plurality of syringe pumps about a rotation axis.

Implementations of the disclosure may include one or more of the following optional features. In some implementations, the system further comprises a controller operatively coupled to the pump motors. In some implementations, the controller is configured to independently control the plurality of syringe pumps. In some implementations, the system further comprises an electrical slip ring. In some implementations, the electrical slip ring is structured and arranged to transmit power and signals between the controller and the plurality of syringe pumps. In some implementations, the rotational motor comprises a stepper motor.

In some implementations, the syringe pump base includes a tower extending axially from the multi-nozzle attachment.

In some implementations, the system comprises a gear mechanism that mechanically couples the rotational motor to the syringe pump base. In some implementations, the system includes a thrust bearing arranged between the gear mechanism and the respective pump motors. In some implementations, the gear mechanism includes a hub mounting gear and a pinion gear. In some implementations, the gear mechanism is arranged on a gear mount. In some implementations, the system includes a motor holder that mounts the respective motors of the plurality of syringe pumps. In some implementations, the motor holder is structured and arranged to prevent relative rotational movement of the plurality of syringe pumps.

In some implementations, the plurality of syringe pumps accommodates bent nozzles and/or straight nozzles.

In some implementations, the rotational motor is directly coupled to the syringe pump base via a shaft. In some implementations, the system comprises an electrical slip ring arranged between the plurality of syringe pumps and the rotational motor, wherein the electrical slip ring has a through-bore that receives the shaft of the rotational motor. In some implementations, the shaft comprises a drive shaft coupled to the rotational motor and a transmission shaft coupled to the syringe pump base, wherein the transmission shaft extends through the electrical slip ring. In some implementations, the system comprises a top plate arranged between the rotational motor and the slip ring, wherein the transmission shaft passes through a bore in the top plate. In some implementations, a thrust bearing is arranged on the top plate at the bore on a side facing the rotational motor.

Another aspect of the disclosure provides a 3D printing system. The 3D printing system comprises a syringe pump base and a multi-nozzle attachment disposed at a bottom of the syringe pump base. The system includes a plurality of syringe pumps mounted to the syringe pump base, each syringe pump including a pump motor and a material reservoir. A rotational motor is operatively coupled to the syringe pump base and is configured to rotate the plurality of syringe pumps about a rotation axis. The system also includes a printing bed, a first-axis motor, a second-axis motor, and a third-axis motor configured to move the printing bed along three orthogonal axes. A controller is configured to position the printing bed during a printing operation by controlling the first-axis, second-axis, and third-axis motors.

Implementations of the disclosure may include one or more of the following optional features. In some implementations, the controller is further configured to independently control the pump motors of the plurality of syringe pumps. In some implementations, the controller is further configured to control the rotational motor to rotate the plurality of syringe pumps about the rotation axis. In some implementations, the rotational motor is mechanically coupled to the syringe pump base by a shaft or a gear assembly.

### DESCRIPTION OF DRAWINGS

The accompanying drawings, which are incorporated in and form part of this specification, together with the description, serve to explain the underlying principles.

FIG. 1 is a schematic illustration of a rotatable extrusion system according to some implementations of the disclosure, showing the overall system configuration with syringe pumps mounted to a rotatable base.

FIG. 2A and FIG. 2B illustrate assembled and exploded views of an individual syringe pump of the rotatable extrusion system, showing the frame/mount, pump motor, and material reservoir, in accordance with some implementations of the disclosure.

FIG. 3 illustrates a syringe pump base with a multi-nozzle attachment of the extrusion system in accordance with some implementations of the disclosure.

FIG. 4 illustrates five syringe pumps arranged around a pentagonal syringe pump base with pump motors secured on a motor holder, demonstrating the circumferential mounting arrangement, in accordance with some implementations of the disclosure.

FIG. 5A and FIG. 5B illustrate assembled and exploded views of a gear-based rotational mechanism of the rotatable extrusion system, showing the thrust bearing, hub mounting gear, pinion gear, and related components, in accordance with some implementations of the disclosure.

FIG. 6A and FIG. 6B illustrate assembled and exploded views of a stepper motor and electrical slip ring assembly mounted on a cover of the syringe pump base, including the controller and drive shaft components, in accordance with some implementations of the disclosure.

FIG. 7A to FIG. 7D show a multi-nozzle attachment configured with a plurality of bent nozzles, in accordance with some implementations of the disclosure.

FIG. 8 illustrates material reservoirs (syringes in this example) in fluid communication with nozzles in a multi-nozzle attachment in accordance with some implementations of the disclosure.

FIG. 9 provides illustrative examples of various parallel patterns that may be fabricated utilizing a rotatable extrusion system, which is operatively coupled to the frame of a 3D printer.

FIG. 10A to FIG. 10C provide illustrative examples of various multi-material printings that may be fabricated utilizing the rotatable extrusion system, which is operatively coupled to the frame of a 3D printer.

FIG. 11 is a schematic illustration of a rotatable extrusion system, featuring a direct-drive rotational mechanism, in accordance with some implementations of the disclosure.

FIG. 12 illustrates a detailed view of the rotational mechanism of the rotatable extrusion system, illustrating the motor mount, transmission shaft, and thrust bearing arrangement, in accordance with some implementations of the disclosure.

FIG. 13 illustrates an exploded view of the direct-drive rotational mechanism, detailing the transmission shaft, top plate, connector, and electrical slip ring assembly in accordance with some implementations of the disclosure.

FIG. 14 illustrates an electrical slip ring which connects control signal wires and power wires from the controller to each syringe pump motors.

FIG. 15 illustrates the complete rotatable extrusion system mounted to a frame via the top plate, demonstrating the integration of the rotational mechanism with supporting structures in accordance with some implementations of the disclosure.

FIG. 16 illustrates the controller configured to control the syringe pumps, rotation of the extrusion system, and movement of the printer's bed, in accordance with some implementations of the disclosure.

### DETAILED DESCRIPTION

The present disclosure describes a rotatable extrusion system designed to fundamentally address the limitations of conventional multi-nozzle, multi-material 3D printing systems. The disclosure provides a comprehensive solution that reduces or eliminates tube twisting, enables efficient material switching, and supports both sequential and parallel multi-material printing operations.

The improvement lies in mounting material reservoirs, syringe pumps, and nozzles on a rotating assembly that moves as a coordinated unit. This approach maintains constant relative positions of all material supply lines, preventing or reducing the tube twisting and entanglement issues that plague conventional multi-nozzle systems.

The rotatable extrusion system may be used across a wide range of applications, including multi-material 3D printing for biomedical devices, electronics, energy storage devices, aerospace components, and other applications requiring precise material deposition and multi-material capabilities.

A. Rotatable System Configured with a Gear or Belt Mechanism

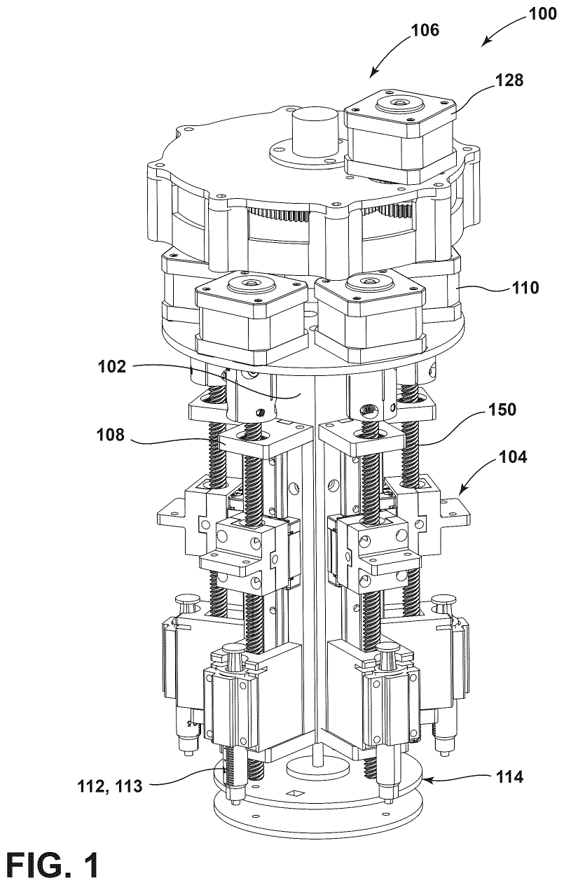

FIG. 1 depicts a rotatable extrusion system 100, equipped with a rotational mechanism 106, in accordance with some implementations of the present disclosure. The rotatable extrusion system 100 comprises a syringe pump base 102 (also referred to as a tower), a plurality of syringe pumps 104 mounted circumferentially about the syringe pump base 102, and the rotational mechanism 106 operable to rotate the syringe pump base 102 and components (e.g., syringe pumps) attached to the syringe pump base 102.

In some implementations, the syringe pump base 102 serves as a central, substantially vertically oriented support structure for the extrusion system 100. The syringe pump base 102 may possess a polygonal, round, or prismatic geometry, which may be selected as a function of the intended number of syringe pumps 104 and process requirements. For example, a pentagonal configuration facilitates mounting of five syringe pumps 104, although the syringe pump base 102 may be formed as a square, hexagon, circle, or other multi-faceted structure to accommodate a differing number of pumps as required. Materials suitable for the construction of syringe pump base 102 include, but are not limited to, anodized aluminum, stainless steel, or engineering-grade polymers, with due consideration to stiffness, weight, and chemical compatibility.

As illustrated, in some implementations, a multi-nozzle attachment 114 is mounted at the lower end of the syringe pump base 102. This nozzle assembly is structured to permit installation of various fluid dispensing tips, which may include straight or bent nozzles, or multi-channel adapter tips, thereby increasing or maximizing compatibility with diverse 3D printing modes. The geometry and orientation of the multi-nozzle attachment 114 advantageously reduce or minimize the path length between each material reservoir 112 and the corresponding nozzle, thereby reducing dead volume, facilitating rapid material transitions, and supporting precise dispensing.

In some implementations, each syringe pump 104 includes a frame 108 (also referred to as a mount) which is rigidly affixed to the syringe pump base 102 by means of mechanical fasteners such as machine screws, threaded inserts, or specialized mounting brackets. In some implementations, adhesive bonding is employed either in combination with, or in lieu of, mechanical fasteners. This securement fixes the position and orientation of each syringe pump 104 relative to the syringe pump base 102 and maintains correct axial and radial alignment for reliable operation.

As shown, in some implementations, disposed at an upper portion of each syringe pump 104 is a pump motor 110. In some implementations, the pump motor 110 is a stepper motor or servo motor, which enables precise control of the actuation of the syringe plunger. The pump motor 110 operably drives a lead screw 150 or rack-and-pinion mechanism to displace the plunger of a material reservoir 112, thereby controlling ejection of a print material.

In some implementations, the material reservoir 112, typically realized as a syringe 113, is disposed at the lower portion of each syringe pump 104 and is removably coupled thereto to facilitate refilling, cleaning, and maintenance. The syringe 113 may be fabricated from glass, polymeric, or metallic materials, depending on chemical resistance, sterility, and mechanical considerations. In some examples, the material reservoir 112 is graduated and equipped with a piston, seal, or check valve to protect against leakage and cross-contamination.

As shown, in some implementations, the plurality of syringe pumps 104 is distributed around the circumference of syringe pump base 102 at uniform angular intervals, optimizing balance during rotation and increasing or maximizing accessibility for parallelized or individually controlled printing operations. This arrangement enables independent servicing or replacement of syringe pumps 104, thereby enhancing the system's modularity and flexibility.

The frames 108 of the syringe pumps 104 are affixed to the syringe pump base 102 with adhesives and/or mechanical fasteners selected for their vibration resistance and durability under repeated rotational cycles. Where mechanical fasteners are employed, alignment pins or dowels may be included to promote accurate and repeatable positioning of each syringe pump 104.

In some implementations, electrical connectivity for each syringe pump 104 is achieved via wiring harnesses routed within, or along, cable management features of the rotatable extrusion system 100. Electrical lines (e.g., wires) connect a system controller to each pump motor 110, with power and control signals routed through an electrical slip ring 134 to maintain continuous, untwisted operation as the syringe pump base 102 rotates.

Seals, gaskets, or dust covers may be employed at interfaces between the syringe pumps 104 and the syringe pump base 102 to protect sensitive internal components from particulates, humidity, or other environmental contaminants. Optionally, the entire assembly may be housed within an environmental enclosure supporting controlled-atmosphere or aseptic operation.

Thus, in accordance with some implementations, the rotatable extrusion system 100 provides a modular, robust platform for high-throughput, multi-material 3D printing. The system architecture enables rapid material switching, precise material dispensing, and both serial and parallel printing modes, all within a compact, mechanically reliable, and easily scalable configuration.

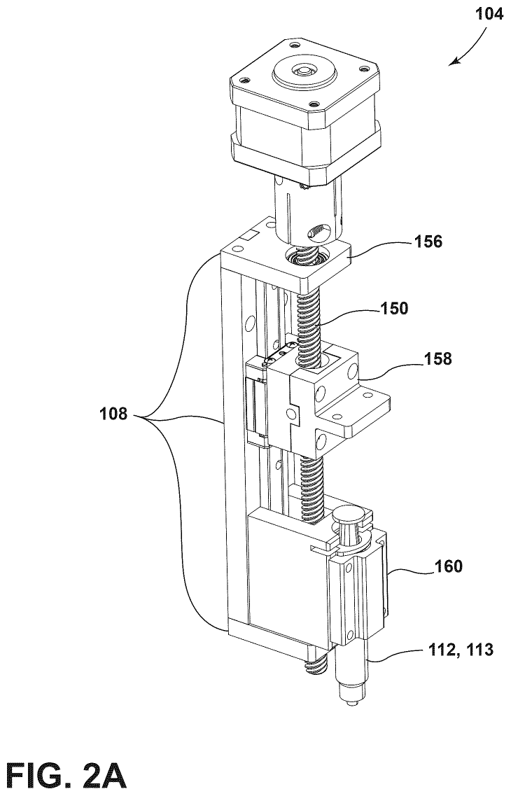

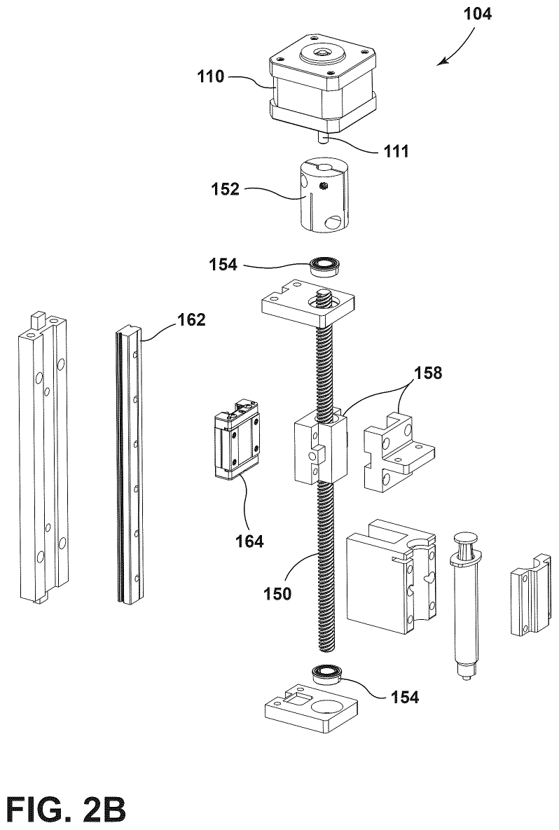

FIG. 2A and FIG. 2B illustrate assembled and exploded views of an individual syringe pump 104 of the rotatable extrusion system 100, showing the frame/mount 108, pump motor 110, and material reservoir 112, in accordance with some implementations of the disclosure.

As shown, in some implementations, the individual syringe pump 104 includes the pump motor 110, a coupler 152, bearings 154, the frame/mount 108, the material reservoir 112 (e.g., syringe 113), a syringe holder 160, a linear rail 162, a carriage 164 coupled to the linear rail 162, the lead screw 150 coupled to a shaft 111 of the pump motor 110 (via the coupler 152), and an ink injector 158 coupled to a lead nut. In some implementations, the ink injector 158 includes the led nut.

As shown, the individual syringe pump 104 is configured to inject precision amount of ink from the material reservoir 112 (e.g., syringe 113) by rotating the shaft 111 of the pump motor 110. Rotating the shaft 111 of the pump motor 100 causes the lead screw 150 to rotate. As a result, the lead nut (enclosed by the ink injector 158) moves linearly in a vertical direction. The ink injector 158 coupled to the lead nut moves linearly as well. As the ink injector 158 pushes down the plunger of the syringe 113, the syringe 113 supplies ink to a nozzle and the nozzle releases (e.g., print) the ink on the printing bed or surface.

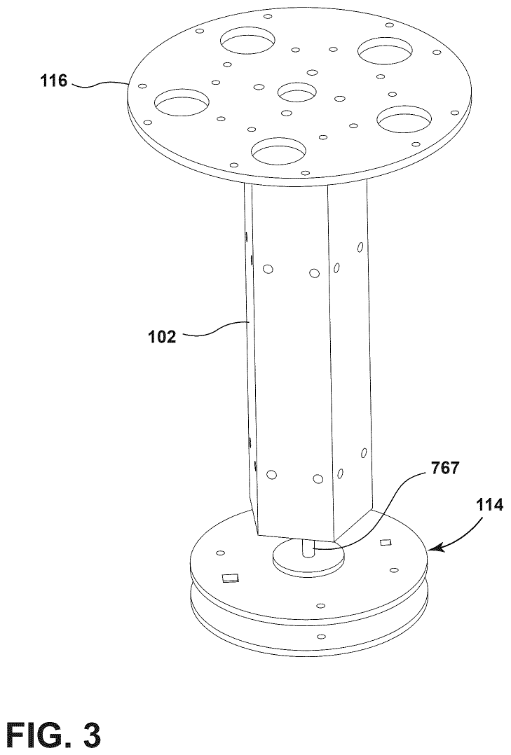

FIG. 3 illustrates a syringe pump base 102 with a multi-nozzle attachment 114 of the extrusion system 100, in accordance with some implementations of the disclosure.

As discussed above, the syringe pump base 102 serves as a central, substantially vertically oriented support structure for the extrusion system 100. The syringe base 102 may possess a polygonal, round, or prismatic geometry, which may be selected as a function of the intended number of syringe pumps 104 and process requirements. For example, a pentagonal configuration facilitates mounting of five syringe pumps 104, although the base 102 may be formed as a square, hexagon, circle, or other multi-faceted structure to accommodate a differing number of pumps as required. Materials suitable for the construction of syringe base 102 include, but are not limited to, anodized aluminum, stainless steel, or engineering-grade polymers, with due consideration to stiffness, weight, and chemical compatibility.

As shown, in some implementations, a motor holder 116 is disposed at the upper portion of the syringe pump base 102. The motor holder 116 is constructed to retain each pump motor 110 in a fixed relationship relative to the rotating base. The motor holder 116 includes a plurality of openings that allow each shaft 111 of the pump motors 110 to mechanically couple to the lead screw 150. This structural feature prevents undesired movement of the pump motors 110 during system operation, while permitting free rotation of each motor's output shaft for independent and precise actuation of the corresponding syringe plunger. The motor holder 116 is configured to maintain stable alignment of the pump motor 110, to reduce mechanical vibration during operation, and to facilitate maintenance and servicing of the pump motor 110 when required.

As shown, in some implementations, the syringe pump base 102 is configured to support a plurality of interchangeable nozzle attachments (multi-nozzle attachment 114 shown in this example) disposed at the lower region of the syringe pump base 102. The nozzle attachments may be removably connected using threaded couplings, quick-release mechanisms, or precision alignment features to accommodate a range of nozzle geometries, including straight nozzles suited for conventional multi-material extrusion, bent nozzles for parallel or offset deposition, or multi-channel adapter assemblies for advanced or specialized 3D printing applications.

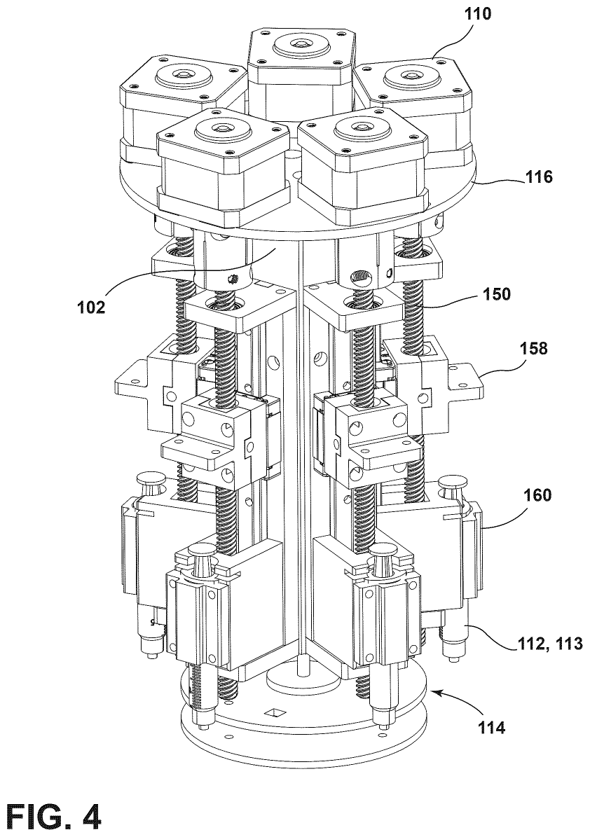

FIG. 4 illustrates five syringe pumps 104 arranged around a pentagonal syringe pump base 102 with pump motors 110 secured on a motor holder 116, demonstrating the circumferential mounting arrangement, in accordance with some implementations of the disclosure.

In some implementations, the syringe pump base 102 is configured with the multi-nozzle attachment 114 disposed at the lower region of the syringe pump base 102. The nozzle attachment may be removably connected using threaded couplings, quick-release mechanisms, or precision alignment features to accommodate a range of nozzle geometries, including straight nozzles suited for conventional multi-material extrusion, bent nozzles for parallel or offset deposition, or multi-channel adapter assemblies for advanced or specialized 3D printing applications. By reducing or minimizing the path length between each material reservoir 112 (e.g., syringe 113) and the respective nozzle, the system 100 reduces dead volume and enables rapid, precise transitions between materials. In this example, a multi-nozzle attachment 114, configured with a plurality of bent nozzles, is mounted to the lower region of the syringe pump base 102.

As shown, in some implementations, the system 100 includes five syringe pumps 104 arranged at uniform angular intervals around a pentagonal configuration of syringe pump base 102. It should be understood, however, that this configuration is presented for illustrative purposes only and is not intended to be limiting. The system 100 may be readily adapted to accommodate a greater or lesser number of syringe pumps 104 by altering the geometric structure of the syringe pump base 102. For example, the syringe pump base 102 may be formed with square, rectangular, hexagonal, circular, heptagonal, or octagonal cross-sections, thereby providing flexibility to satisfy a variety of application-specific requirements regarding system capacity and throughput.

As shown, in some implementations, the motor holder 116 is disposed at the upper portion of the syringe pump base 102. The motor holder 116 is constructed to retain each pump motor 110 in a fixed relationship relative to the rotating base. This structural feature prevents undesired movement of the pump motors 110 during system operation, while permitting free rotation of each motor's output shaft for independent and precise actuation of the corresponding syringe plunger. The use of such a motor holder 116 ensures stable alignment, reduces mechanical vibration, and facilitates maintenance and servicing of the pump motors 110 as needed. The motor holder 116 is configured to maintain stable alignment of the pump motor 110, to reduce mechanical vibration during operation, and to facilitate maintenance and servicing of the pump motor 110 when required.

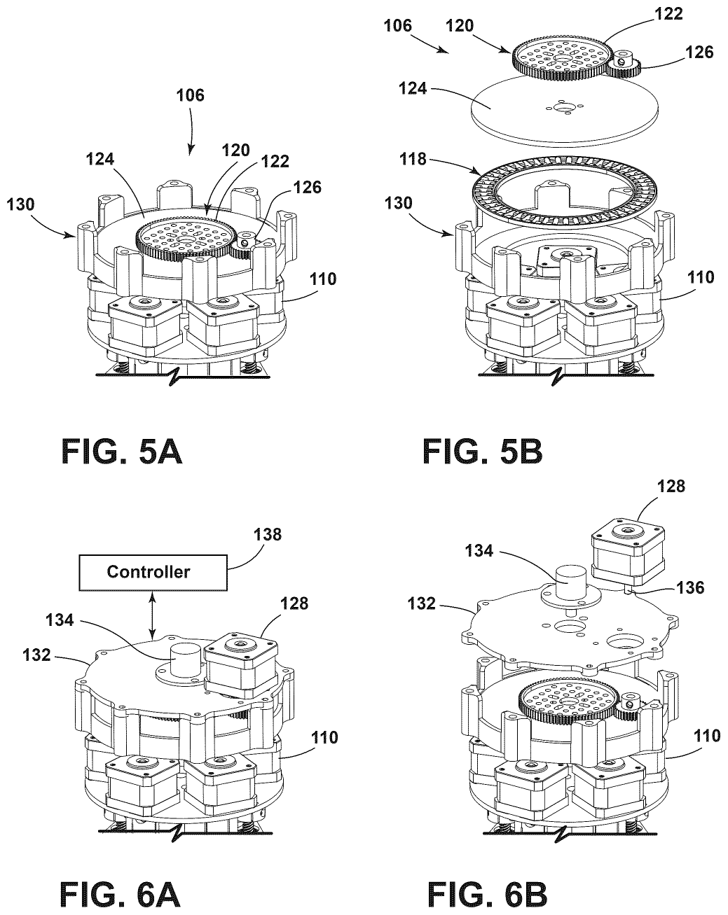

FIG. 5A and FIG. 5B illustrate assembled and exploded views of a gear-based rotational mechanism 106 of the rotatable extrusion system 100, showing a thrust bearing 118, a hub mounting gear 122, a pinion gear 126, and related components, in accordance with some implementations of the disclosure.

As shown, in some implementations, the rotational mechanism 106 includes the thrust bearing 118 and a gear mechanism 120. The thrust bearing 118 is configured to support axial loads generated by the combined mass of the rotating assembly and to reduce or minimize friction at the interface between moving and stationary components, thereby promoting smooth and durable rotational operation throughout prolonged use.

As shown, in some implementations, the gear mechanism 120 comprises the hub mounting gear 122, which mechanically couples the syringe pump base 102 to the base cover 124 and provides an interface for torque transfer to the rotating elements (e.g., syringe pump base 102, the syringe pumps 104 mounted to the syringe pump base 102). The pinion gear 126, operably connected to a rotational motor 128—preferably a stepper motor for precise positional control—engages the hub mounting gear 122. Rotational actuation of the rotational motor 128 results in the rotation of the pinion gear 126, which, in turn, drives the hub mounting gear 122, and thereby causes coordinated rotation of the syringe pump base 102 and the attached syringe pumps 104. The entire gear mechanism 120 is supported and constrained by a gear mount 130, ensuring stable operation and proper alignment of all moving parts. The selection of gear ratio between the pinion gear 126 and the hub mounting gear 122 may be tailored to achieve specific application requirements, such as increased output torque or enhanced rotational speed for material switching. In some implementation, the gear mechanism 120 can be replaced with a belt mechanism.

FIG. 6A and FIG. 6B illustrate assembled and exploded views of the rotational motor 128 and electrical slip ring 134 mounted on a top cover 132 of the syringe pump base 102, including a main controller 138 and drive shaft 136, in accordance with some implementations of the disclosure.

As shown, in some implementations, the top cover 132 is provided to secure and align both the electrical slip ring 134 and the rotational motor 128 relative to the rest of the assembly. The rotational motor 128 (e.g., stepper motor) is equipped with the drive shaft 136, which directly engages with the pinion gear 126 to transmit rotational power.

In some implementations, centralized electronic management and control of the entire system 100 is achieved via the main controller 138, which may be implemented as a printed circuit board (PCB) or other electronic control unit. The main controller 138 is operatively connected to the rotational motor 128 as well as to each individual pump motor 110, thereby enabling coordinated control, monitoring, and adjustment of all dynamic functions associated with both rotation and material dispensing.

As discussed above, each pump motor 110 receives electrical power and control signals through the electrical slip ring 134. The slip ring 134 enables continuous electrical communication between the main controller 138 (which is stationary) and the rotating syringe pumps 104, thus reducing or preventing wiring twisting and ensuring uninterrupted control of the syringe pumps 104 during extended or multi-rotation printing processes. The slip ring 134 is preferably configured to accommodate multiple independent circuits to allow for separate control and power delivery to each pump motor 110. This structural arrangement enables independent, precise, and continuous actuation of each syringe pump regardless of the system's rotational position.

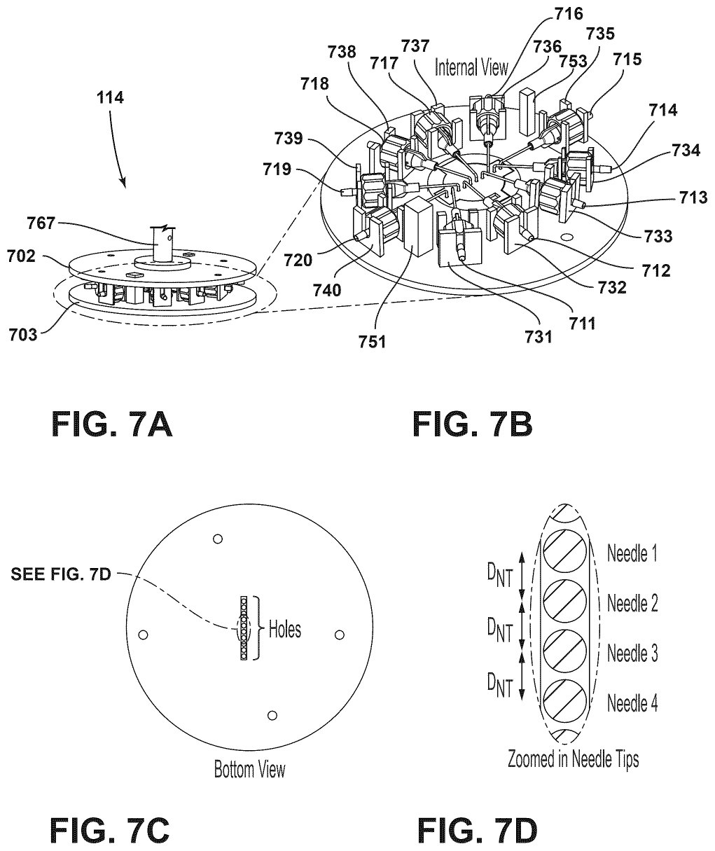

FIGS. 7A-FIG. 7D show an example multi-nozzle attachment 114 configured with a plurality of bent nozzles 711-720 in accordance with some implementations of the disclosure.

As shown in FIGS. 7A-FIG. 7D, in some implementations, the multi-nozzle attachment 114 includes two plates (a cover plate 702 and a base plate 703 in this example) that secure the luck lock nozzles 711-720 in place. The base plate 703 may have multiple holes to accommodate the tips of nozzles 711-720 (also referred to as needles). The tips of nozzles 711-720 may be located centrally in a predefined pattern with the hubs radially outwards and spaced circumferentially along the plates. The holes provide openings so that the tips of nozzles 711-720 can be located close to the printing bed. Additionally, the base plate 703 can include a holding structure 731-740 (also referred to as nozzle slot) for each 90-degree bent nozzle 711-720 to keep the tips securely positioned within the holes. In this example, the variable DNT represents the distance between the two nozzle tips.

In some implementations, each holding structure 731-740 features two open slots, allowing the nozzles 711-720 to be easily placed onto the holding structures 731-740. This configuration ensures the tips are aligned according to the pattern of holes on the base plate 703. In this example, the holes are arranged linearly (also referred to as straight-line configuration). The base plate 703 may also include coupling structures 751, 753 (e.g., two in this example) for attaching the base plate 703 to the cover plate 702. The base plate 703 may be also referred to as a housing or nozzle housing. The base plate 703 along with the cover plate 702 may be referred to as a housing or nozzle housing.

In some implementations, the cover plate 702 is coupled to the rotating end 767 of the syringe pump base 102. As the syringe pump base 102 rotates (e.g., clockwise, counterclockwise, combination of clockwise and counterclockwise), the cover plate 702 rotates accordingly, causing the tips of nozzle 711-720, positioned between the plates, to rotate. This configuration enables the syringe pump base 102 to provide rotational motion around the Z-axis.

With the syringe pump base 102 securely mounted to the 3D printer's frame (for example, a Creality Ender Pro 3), the nozzle tips 711-720 can move along the X, Y, and Z directions.

In this example, each of 10 syringes 113 (syringe pumps 104) is in fluid communication with a corresponding nozzle of the nozzles 711-720 in the multi-nozzle attachment 114.

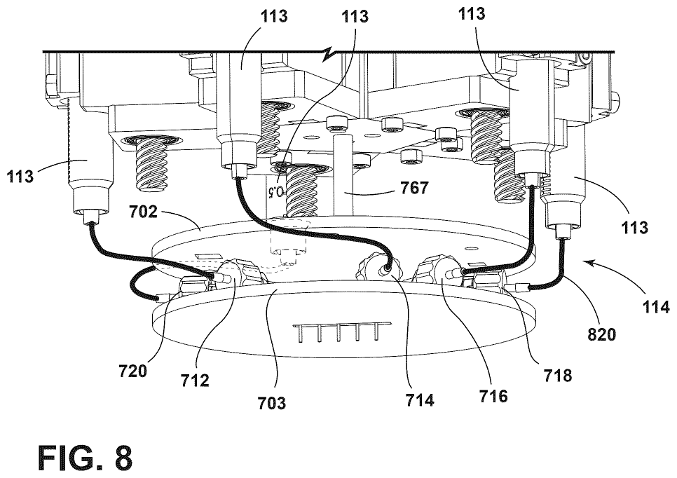

FIG. 8 illustrates the syringes 113 in fluid communication with the nozzles 711-720 in the multi-nozzle attachment 114 in accordance with some implementations of the disclosure. In this example, the multi-nozzle attachment 114 comprises five bent nozzles—712, 714, 716, 718, and 720—each of which is in fluid communication with a corresponding syringe 113. In this implementation, tubes 820 are used to establish the fluid communication.

As illustrated, each syringe 113 is directly connected to an associated nozzle in the multi-nozzle attachment 114, allowing for precise delivery of materials. When ink or other material is supplied from a given syringe 113, it is transferred through the corresponding nozzle, which dispenses the material at the needle tip.

In some implementations, each nozzle may be supplied with a different material, enabling the multi-nozzle attachment 114 to dispense multiple types of material simultaneously. Alternatively, all nozzles may be charged with the same material, depending on the specific substances loaded into the syringes. This versatility allows the system to accommodate a range of additive manufacturing or dispensing applications based on user needs.

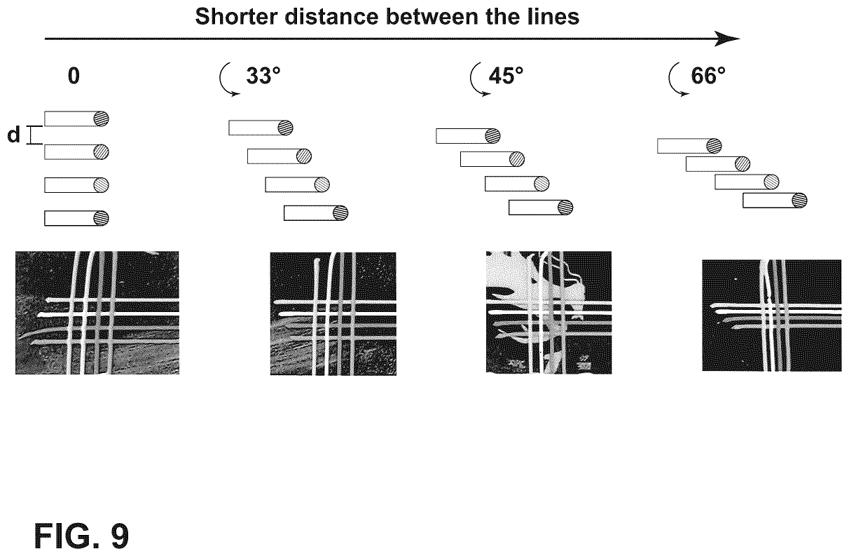

FIG. 9 provides illustrative examples of various parallel patterns that may be fabricated utilizing the rotatable extrusion system 100, which is operatively coupled to the frame of a 3D printer.

As discussed, the rotatable extrusion system 100 comprises a plurality of nozzles (nozzles 712, 714, 716, 718 in this example), each capable of dispensing a different material, and is configured to rotate about the Z-axis relative to the printer's frame.

In a first configuration, where the extrusion system 100 is positioned in a non-rotated, or neutral, orientation (i.e., no angular displacement from the reference axis), the system deposits a series of four continuous lines in the X-direction, with each line formed by a distinct material dispensed from a separate nozzle. An analogous set of four lines is then deposited in the Y-direction, intersecting with the X-direction lines to collectively create a two-dimensional mesh pattern, wherein the intersection points comprise combinations of different materials.

When the extrusion system 100 is rotated to an angle of 33 degrees relative to its initial orientation, the apparatus deposits a set of four lines in the X-direction, and a corresponding set of four lines in the Y-direction, as before. Each line is composed of a unique material extruded from a separate nozzle. Due to the angular rotation, the positional relationship and spacing between these lines is altered, producing a mesh pattern with modified geometry and distribution of materials at the intersections compared to the non-rotated configuration.

Upon rotating the extrusion system 100 to 45 degrees, a similar process is repeated: four lines, each of a separate material, are extruded in the X-direction, with a corresponding group of four lines in the Y-direction. The rotation results in distinctly oriented mesh elements and altered line-to-line spacing and intersection arrangements, further varying the structural and material characteristics of the resulting mesh.

At a rotational displacement of 66 degrees, the extrusion system 100 likewise forms a mesh pattern through deposition of four material lines in the X-direction and four in the Y-direction, each line associated with an individual material. The greater rotation angle further modifies the mesh geometry, line spacing, and overlap regions, allowing additional variation in the architecture and composition of the printed construct.

These various configurations demonstrate that rotation of the multi-nozzle extrusion system 100 significantly affects the spatial arrangement and separation of the deposited lines. Notably, the physical distance between the nozzle tips within the extrusion system remains fixed throughout, and only the orientation of the nozzle array with respect to the build plane is altered. As a result, the apparent spacing and overlap of extruded lines at the substrate can be precisely controlled by adjusting the rotation angle of the extrusion system.

This rotational capability enables the printing of functionally graded materials (“FGMs”), where the local properties of the printed object—such as density, stiffness, or composition—can be varied in a controlled manner by modifying both the distribution and combination of materials at different locations within the mesh structure.

In particular, for applications in bio-printing, the ability to finely tune the pattern of voids and the arrangement of multiple biomaterials enables the fabrication of constructs with spatially varying physical and biological properties. For example, specific regions of a printed scaffold can be made denser, more porous, or composed of different bioactive agents, thereby tailoring the resulting structure for varied cellular responses or mechanical performance within a single printed object.

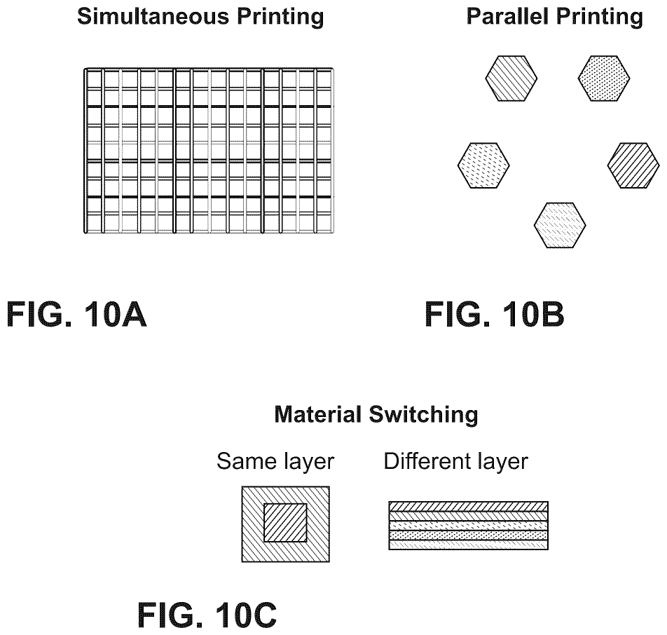

FIGS. 10A-10C illustrate various examples of multi-material printing patterns and methods that are achievable using the rotatable extrusion system 100, which is mechanically integrated with the frame of a 3D printer, in accordance with some implementations of the disclosure.

In some configurations, the rotatable extrusion system 100 includes a plurality of nozzle tips, each in fluid communication with a corresponding syringe or reservoir, wherein each syringe is configured to dispense a different material. The nozzles may be arranged in either bent or straight orientations and are independently actuated during printing operations.

The system enables simultaneous multi-material printing through the use of a nozzle attachment equipped with multiple bent-nozzles. In this arrangement, each nozzle dispenses a distinct material concurrently onto designated regions of the printing bed. Independent control over each nozzle's flow rate and extrusion path facilitates accurate spatial placement of multiple materials in a single printing process. This capability permits the formation of gradients, interfaces, or other complex patterns involving more than one material within a single print layer, with precise spatial resolution achieved via programmable control (see FIG. 10A).

Alternatively, the print head may be configured with an array of straight nozzles arranged in parallel, with each nozzle separated by a fixed pitch. This configuration allows for the simultaneous deposition of identical or similar geometric features using different materials. As a result, the system supports the parallel fabrication of multiple test samples or components, each with a distinct material composition. Such parallel processing enhances throughput and productivity, and enables rapid prototyping, batch manufacturing, or comparative evaluation of multiple materials under substantially identical process conditions (see FIG. 10B).

Furthermore, the rotatable multi-nozzle system provides for rapid and efficient switching between different extruded materials. By rotating the print head, any selected nozzle may be positioned above the build plane for active dispensing, thereby eliminating the need for manual nozzle exchange or operational delays. This rotational nozzle selection enables seamless transitions between materials within a single print layer or across successive layers, supporting the production of complex structures characterized by discrete or graded interfaces and affording enhanced control over material distribution throughout the printed object (see FIG. 10C).

Collectively, the above-described features of the rotatable extrusion system 100 provide robust mechanical stability, precise operational control, modular scalability, and case of maintenance. The system's architecture facilitates efficient multi-material and high-throughput 3D printing, enabling both sequential and parallel printing modes, and supporting advanced material-switching and process flexibility in a compact, integrated design.

B. Rotatable System Configured with a Direct-Drive Rotational Mechanism

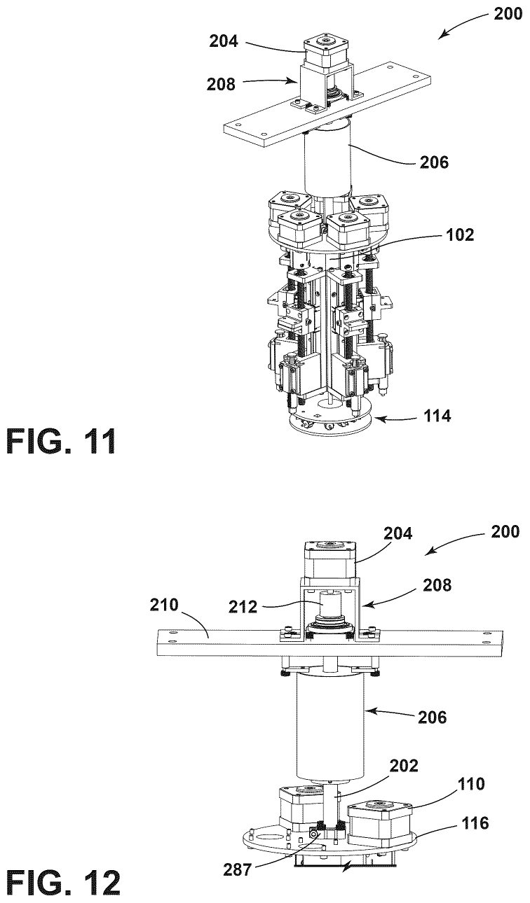

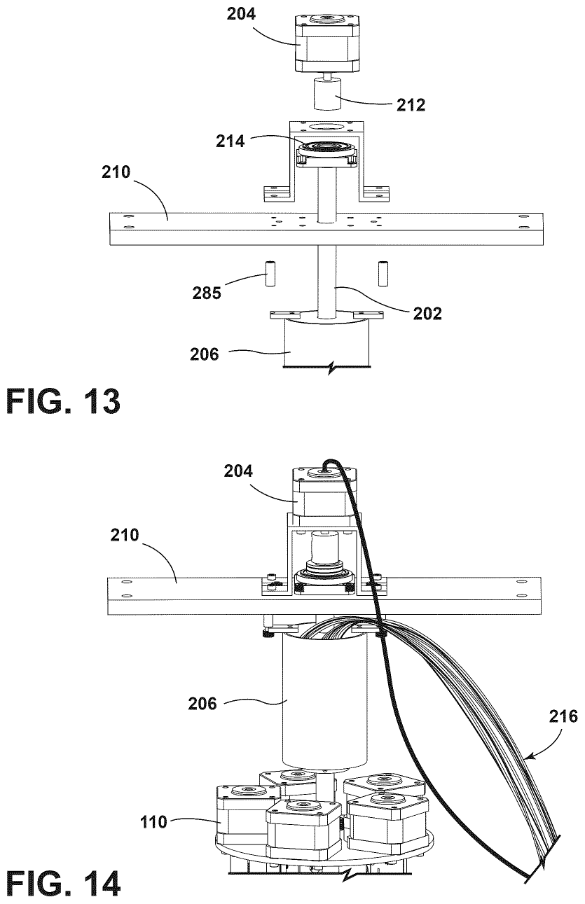

FIGS. 11-15 show a rotatable extrusion system 200 that features a direct-drive rotational mechanism, in accordance with some implementations of the disclosure. The system 200 comprises the direct-drive rotational mechanism that enhances system reliability and efficiency by eliminating intermediate gearing found in the rotatable extrusion system 100 configured with the gear mechanism 120. It will be appreciated that the rotatable extrusion system 200 may provide the patterns and configurations illustrated in FIG. 9, and/or achieve the multi-material printing patterns and methods illustrated in FIGS. 10A-10C. It will further be appreciated that the multi-nozzle attachment 114 described in detail with reference to FIGS. 7A-7D and FIG. 8 may be employed with the rotatably extrusion system 200.

As shown, in some implementations, the rotatable extrusion system 200 includes a transmission shaft 202 extending longitudinally through the syringe pump base 102 (motor holder 116 of the syringe pump base 102 in this example). The transmission shaft 202 is directly coupled to a rotational motor 204, which may comprise a stepper motor, servo motor, or another suitable rotary actuator as required by the specific application. Direct coupling of the transmission shaft 202 to the rotational motor 204 obviates the need for a gear reduction mechanism, thereby reducing mechanical complexity, reducing or minimizing potential for gear backlash, and permitting smoother and more precise rotational movement. This configuration further reduces maintenance requirements and improves system durability.

As shown, in some implementations, an electrical slip ring 206 is disposed between the rotational motor 204 and the syringe pump base. The slip ring 206 features a through-bore configuration, dimensioned to permit the transmission shaft 202 to pass coaxially through its central axis. This allows for continuous unimpeded rotation of the syringe pump base 102 while maintaining reliable electrical connections to on-board syringe pump motors 100. The slip ring 206 is secured to a stationary top plate 210, typically via bolts, screws, or comparable fasteners. The slip ring 206 retains electrical conductors to provide necessary power and control signals from a stationary controller 138 to the syringe pump motors 110 mounted on the rotating assembly.

As shown, in some implementations, the rotational motor 204 is mounted on a motor mount 208, which is, in turn, attached to the top plate 210. The drive shaft 212 of the rotational motor 204 is joined to the transmission shaft 202 by means of a thrust bearing 214. The thrust bearing 214 axially supports loads generated during rotational movement, enables smooth rotation, and may be dimensionally smaller than corresponding bearings in prior art devices due to direct force transmission and reduced assembly complexity.

The transmission shaft 202 is configured to transmit torque directly to the syringe pump base 102, which may be affixed via a clamping hub 287 or similar securing means. In some implementations, the drive shaft 212 and the transmission shaft 202 are configured as separate components to facilitate case of maintenance and component replacement. In some implementations, the drive and transmission shafts may be realized as a single, integral unit.

FIG. 14 illustrates an electrical slip ring 206 that connects control signal wires and power wires from the controller 138 to each syringe pump motors 110.

As shown, in some implementations, control signal wires and power wires 216 are routed through the electrical slip ring 206, enabling continuous connectivity of the syringe pump motors 110 with the controller 138 regardless of rotational position. The electrical slip ring 206 is fixed with respect to the top plate 210 (via connectors 285 in this example), while the transmission shaft 202 and associated components are free to rotate therein.

Operation of the system 200 is managed by the controller 138 (such as a microprocessor, embedded controller, digital signal processor, or FPGA), which is programmed to independently actuate each syringe pump 110 and command the rotational motor 204 to achieve precise angular positioning of the syringe pump base 102. Position control may be achieved using rotary encoders, step counting, or other position-sensing feedback devices to ensure accurate registration of each syringe pump.

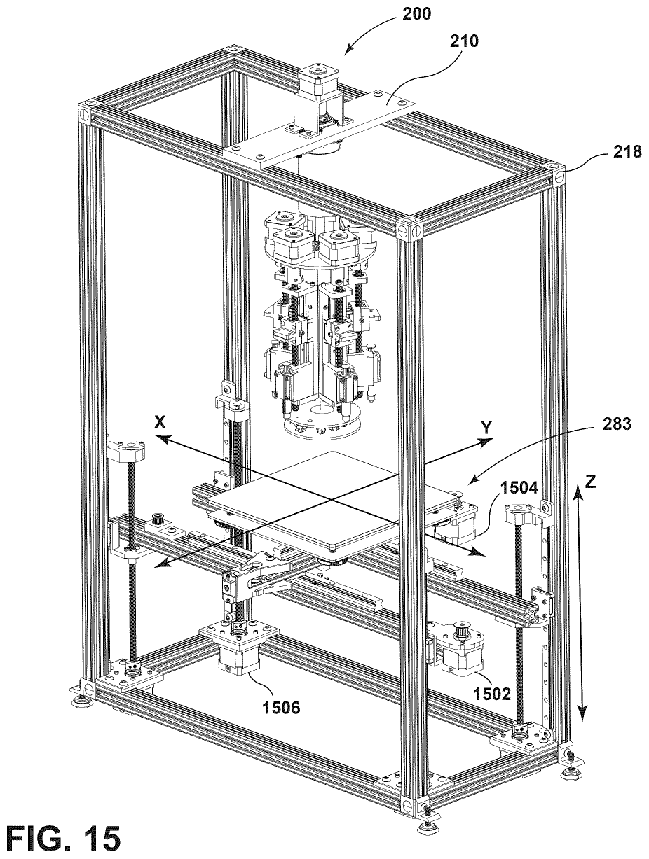

FIG. 15 illustrates the complete rotatable extrusion system 200 mounted to a support frame 218 via the top plate, demonstrating the integration of the rotational mechanism with supporting structures in accordance with some implementations of the disclosure.

As depicted, the entire rotatable extrusion system 200 is rigidly secured to the support frame 218 by means of the top plate 210. This robust mounting not only ensures mechanical stability during operation but also simplifies the alignment of the extrusion system with external components. The structural configuration of the support frame and top plate allows the extrusion system 200 to be compatible with, and easily incorporated into, various 3D printing platforms, robotic manipulators, and automated manufacturing apparatuses, thereby enhancing its versatility and applicability across different fabrication environments.

In some implementations, the controller 138 is operably coupled to the X-axis, Y-axis, and Z-axis motors 1502, 1504, and 1506 of the 3D printing platform, enabling precise, three-dimensional positioning of the print bed 283. In some implementations, the controller 138 is further configured to independently actuate each syringe pump 110, permitting discrete control over material flow from each syringe 113. Additionally, the controller 138 can command the rotational motor 204, allowing for accurate angular adjustment of the syringe pump base 102. By coordinating movement along the X, Y, and Z axes, and managing the rotational orientation of the extrusion system 200, the controller 138 can precisely position the print bed 283 and regulate the deposition process. This degree of control supports advanced printing operations, such as multi-material deposition, variable orientation extrusion, and complex path planning, thereby expanding the functionality of the overall system.

In some implementations, the rotatable extrusion system 100 is mounted to the support frame using any suitable coupling mechanism, thereby enabling the rotatable extrusion system 100 to perform printing operations in a manner similar to the rotatable extrusion system 200.

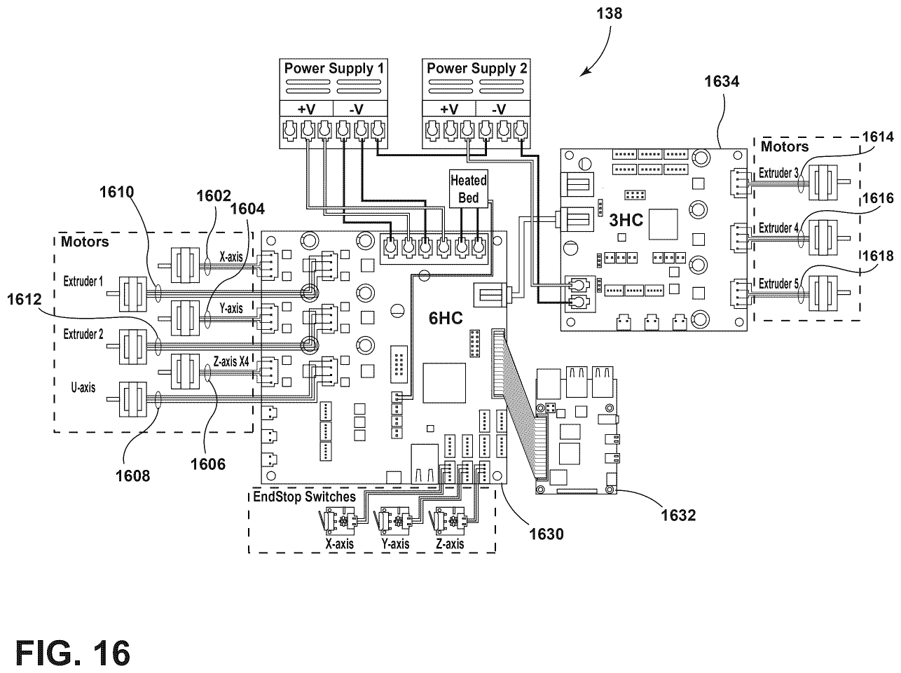

FIG. 16 illustrates the controller 138, which is configured to control the syringe pumps 104, the rotation of the extrusion system (e.g., extrusion system 100, extrusion system 200), and the movement of the printer bed 283, in accordance with some implementations of the present disclosure.

In some implementations, the controller 138 comprises an advanced control board having one or more processors, memory storage, hardware interfaces, and software modules. The controller 138 is electrically and operatively coupled to the rotatable extrusion system and to various motors and actuators associated with the 3D printer. In one example, the controller 138 may be implemented using a Duet 6HC main board 1630 (along with a computing module such as Raspberry Pi 1632), which is configured to independently control up to six motors. In this example, the Raspberry Pi 1632 includes at least one processor and memory storge. To facilitate the control of additional axes or peripheral components, a 3HC expansion board 1634 may be incorporated in operative communication with the 6HC main board 1630, thereby enabling coordinated control of up to nine independent motors. In modular system configurations, additional expansion boards may be integrated as needed to accommodate more actuators or functionalities, providing scalability to support increasingly complex system requirements.

As shown in FIG. 16, the Duct 6HC main board 1630 is operatively connected to provide regulated power and control signals, denoted as 1602, 1604, and 1606, to the X-axis, Y-axis, and Z-axis motors 1502, 1504, and 1506 of the 3D printing platform, respectively. This arrangement enables precise and independent adjustment of the printer bed 283 along three orthogonal axes, thereby facilitating accurate three-dimensional positioning and layer-wise material deposition during the additive manufacturing process.

As shown, the Duet 6HC main board 1630 also supplies power and a control signal 1608 to the rotational motor (such as rotation motor 128 or rotation motor 204), permitting the controller 138 to modulate the angular position of the syringe pump base 102 in relation to the overall system. This functionality supports dynamic reorientation of the extrusion nozzles during operation, enabling complex geometries, toolpath strategies, and multi-axis printing maneuvers.

Additionally, both the Duct 6HC main board 1630 and the 3HC expansion board 1634 are configured to transmit power and control signals—denoted as 1610, 1612, 1614, 1616, and 1618 in FIG. 16—respectively to the first through fifth motors of the five syringe pumps (110). This distributed and synchronized control enables independent operation of the syringe pumps 104, allowing for selective dispensing of different materials, precise regulation of material flow rates, and execution of coordinated, multi-material print routines.

The described control system architecture is inherently modular and expandable, allowing future enhancement by integration of additional expansion boards to address further motors or actuators as necessary. Accordingly, the extrusion and printing system may be readily adapted for greater operational complexity, increased printing throughput, or assimilation of additional features. It is contemplated that alternative advanced control boards or microcontroller systems with substantially similar or superior capabilities can also be utilized to implement the control functions described herein, thereby providing flexibility and broad compatibility with a wide variety of hardware configurations.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. All matter contained in the above description or shown in the accompanying drawings shall be interpreted as illustrative only and not limiting. Changes in detail or structure may be made without departing from the present disclosure.

What is claimed is:

1. A rotatable extrusion system comprising:
a syringe pump base;
a multi-nozzle attachment disposed at a bottom of the syringe pump base;
a plurality of syringe pumps mounted to the syringe pump base, each syringe pump having a pump motor and a material reservoir; and
a rotational motor operatively coupled to the syringe pump base, the rotational motor configured to rotate the syringe pump base and the mounted plurality of syringe pumps about a rotation axis.

2. The system of claim 1, further comprising a controller operatively coupled to the respective pump motors, the controller configured to independently control the plurality of syringe pumps.

3. The system of claim 2, further comprising an electrical slip ring, structured and arranged to transmit power and signals between the controller and the plurality of syringe pumps.

4. The system of claim 1, wherein the rotational motor comprises a stepper motor.

5. The system of claim 1, wherein the syringe pump base comprises a tower extending axially from the multi-nozzle attachment.

6. The system of claim 1, further comprising a gear mechanism that mechanically couples the rotational motor to the syringe pump base.

7. The system of claim 6, further comprising a thrust bearing arranged between the gear mechanism and the respective pump motors.

8. The system of claim 6, wherein the gear mechanism includes a hub mounting gear and a pinion gear.

9. The system of claim 6, wherein the gear mechanism is arranged on a gear mount.

10. The system of claim 1, further comprising a motor holder that mounts the respective motors of the plurality of syringe pumps, the motor holder structured and arranged to prevent relative rotational movement of the plurality of syringe pumps.

11. The system of claim 1, wherein the plurality of syringe pumps accommodate bent nozzles and/or straight nozzles.

12. The system of claim 1, wherein the rotational motor is directly coupled to the syringe pump base via a shaft.

13. The system of claim 12, further comprising an electrical slip ring arranged between the plurality of syringe pumps and the rotational motor, wherein the electrical slip ring has a through-bore that receives the shaft of the rotational motor.

14. The system of claim 13, wherein the shaft comprises a drive shaft coupled to the rotational motor and a transmission shaft coupled to the syringe pump base, wherein the transmission shaft extends through the electrical slip ring.

15. The system of claim 14, further comprising a top plate arranged between the rotational motor and the slip ring, wherein the transmission shaft passes through a bore in the top plate.

16. The system of claim 15, further comprising a thrust bearing arranged on the top plate at the bore on a side facing the rotational motor.

17. A 3D printing system, comprising:
a syringe pump base;
a multi-nozzle attachment disposed at a bottom of the syringe pump base;
a plurality of syringe pumps mounted to the syringe pump base, each syringe pump including a pump motor and a material reservoir;
a rotational motor operatively coupled to the syringe pump base and configured to rotate the plurality of syringe pumps about a rotation axis;
a printing bed;
a first-axis motor, a second-axis motor, and a third-axis motor configured to move the printing bed along three orthogonal axes; and
a controller configured to position the printing bed during a printing operation by controlling the first-axis, second-axis, and third-axis motors.

18. The system of claim 17, wherein the controller is further configured to independently control the pump motors of the plurality of syringe pumps.

19. The system of claim 17, wherein the controller is further configured to control the rotational motor to rotate the plurality of syringe pumps about the rotation axis.

20. The system of claim 17, wherein the rotational motor is mechanically coupled to the syringe pump base by a shaft or a gear assembly.
